(19) United States
(12) Patent Application Publication
(10) Pub. No.: US 2005/0215385 A1
(43) Pub. Date: Sep. 29, 2005

(54) Planetary gear

(75) Inventors: David Spielmann, Geltendorf (DE); Armin Breitenmoser, Wattwil (CH)

Correspondence Address: DAVID TOREN, ESQ.;ABELMAN FRAYNE & SCHWAB, 666 THIRD AVENUE, NEW YORK, NY, 10017-5621, US

(73) Assignee: Hilti Aktiengesellschaft

(21) Appl. No.: 11/077,767

(22) Filed: Mar. 10, 2005

(30) Foreign Application Priority Data
Mar. 10, 2004 (DE) 10 2004 011 617.2

(51) Int. Cl. F16H 3/44

(52) U.S. Cl. 475/298

(57) ABSTRACT

A planetary gear (7) includes a gear block (6) having at least two planetary stages (12, 14) and at least partially located in gear housing (4), and a hollow gear (16) arranged between the gear housing (4) and the gear block (6), axially displaceable in the gear housing (4), and supported against at least two support elements (30) provided on the inner surface (28) of the gear housing (4).

### BACKGROUND OF THE INVENTION

1. Field of the Invention

The present invention relates to a planetary gear, in particular, of a hand-held power tool such as, e.g., a drilling screw and including a gear housing, a gear block having at least two planetary stages and at least partially located in the housing, and a hollow gear arranged between the housing and the gear block and axially displaceable relative to the housing for shifting the planetary gear between at least two shifting stages.

2. Description of the Prior Art

Gear-shiftable planetary gears are generally known and provide for adaptation of a driven-side torque to different operational conditions of a hand-held power tool.

German Publication DE 19902187 discloses a planetary gear of an electrical hand-held tool a hollow gear of which is axially displaceable by a sliding shifting member to effect gear shifting. For displacing the hollow gear, the shifting member is connected with the hollow gear by a wire bracket that projects through corresponding through-openings in the gear housing. In order to prevent tilting of the hollow gear, the wire bracket holds the hollow gear in a central position relative to the housing.

The centering of the hollow gear with the wire bracket prevents the hollow gear, together with the gear block, from sagging in a turn-off condition of the tool and which can cause an increased wear and vibrations.

The drawback of the known planetary gear consists in that the manufacture and assembly of the wire bracket is relatively expensive. In addition, the wire bracket can be easily bent during assembly or during the operation of the tool, which can lead to tilting of the hollow gear or to sagging of the gear block in the turn-off condition of the tool, which again can cause vibrations and an increased wear, in particular when the tool is started.

Accordingly, an object of the present invention is to provide a planetary gear in which the drawbacks of the known planetary gear are eliminated.

Another object of the present invention is to provide a planetary gear with an increased service life.

### SUMMARY OF THE INVENTION

These and other objects of the present invention, which will become apparent hereinafter, are achieved by providing, on an inner surface of the gear housing, at least two support elements against which the hollow gear is supported.

The support elements permit to achieve, by simple means, a particularly precise centering of the gear block with a hollow gear. The support elements can be formed integrally with the housing. If needed, the manufacturing tolerances can be compensated by a simple subsequent treatment of the support elements in order to achieve a particularly precise centering.

Advantageously, the support elements support, via the hollow gear, the intermediate planetary stage. The intermediate planetary stage is formed by one of the planetary stages of the gear block and is arranged between two other stages. In this way, the gear block is supported in its center region, whereby a precise centering of the gear block over its entire length can be insured.

According to a particularly advantageous embodiment of the present invention, the support elements are formed by ribs that project from the inner surface of the gear housing. The formation of support elements as ribs permits to reduce contact surfaces between the gear housing and the hollow gear, which insures a low-friction sliding of the hollow gear in the gear housing. This provides for a convenient shifting of the planetary gear.

Advantageously, there are provided three, preferably, six ribs, which insures a stable centering of the hollow gear and, thereby, of the gear block.

Advantageously, the three, preferably, six ribs are equidistantly angularly spaced from each other. This simplifies manufacturing of the gear housing.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side, partially cross-sectional view of a planetary gear according to the present invention; and

FIG. 2 a cross-sectional view along line II-II in FIG. 1 of the gear housing of the inventive planetary gear with a hollow gear supported therein.

### DETAILED DESCRIPTION OF THE PREFERRED EMBODIMENT

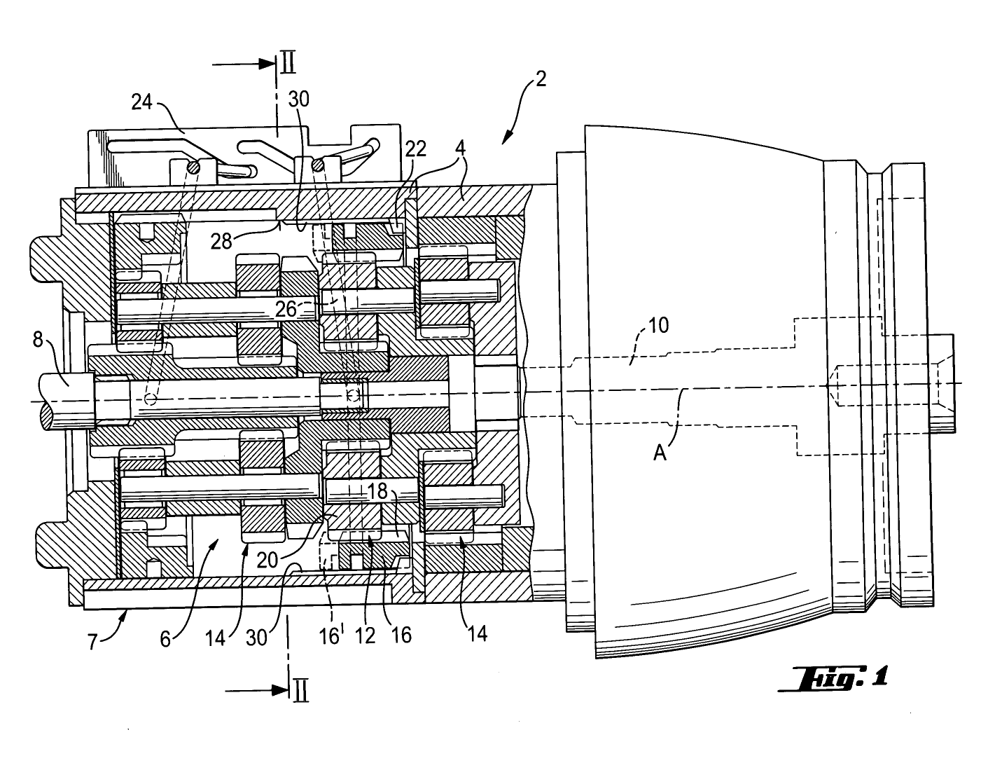

FIG. 1 shows a transmission region 2 of a hand-held power tool which is formed as a drilling screw. The transmission region 2 includes a gear block 6 of a planetary gear 7 which is located in a gear housing 4. The planetary gear 7 has a drive shaft 8 which is connected with a drive 10 that is formed as a spindle of the power tool. The gear block 6 has an intermediate planetary stage 12 arranged between two other planetary stages 14.

The intermediate planetary stage 12 is arranged in a hollow gear 16 having an inner toothing 18. The intermediate planetary stage 12 includes several planetary gears 20 engageable with the inner toothing 18 of the hollow gear 16 when the hollow gear 16 is secured in the gear housing 4 with a connection element 22. In this position of the hollow gear 16, the planetary gear 7 is in its first shifting stage.

In order to shift the planetary gear 7 into its second shifting stage, a sliding shifting member 24, which is connected with the hollow gear 16 by a bracket 26 shown with dash lines, is activated. The displacement of the shifting member 24 leads to a pivotal movement of the bracket 26. The bracket 26 displaces, as a result of its pivotal movement, the hollow gear 16 parallel to axis A of the gear block 6 in the direction of the drive shaft 8. The hollow gear 16 slides relatives to the gear housing 4 into position 16′ shown with dash lines. In this position of the hollow gear 16, the connection element 22 is separated from the hollow gear 16, and the planetary gear 7 occupies its second shifting position or stage.

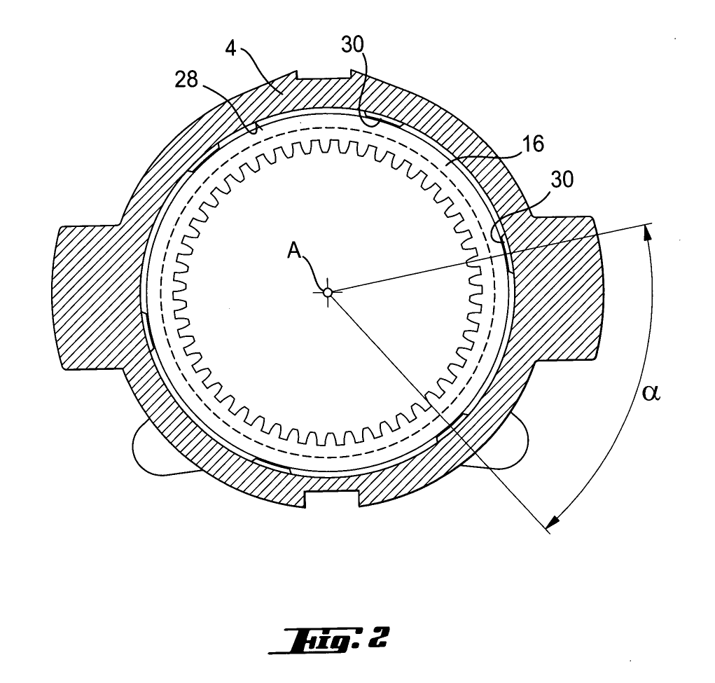

In order to insure an easy displacement of the hollow gear 16 relative to the gear housing 4 without tilting and with an insignificant friction, there are provided on the inner surface 28 of the gear housing 4, six rib-shaped support elements 30, as particularly shown in FIG. 2. The support elements 30 are arranged about the axis A at the same angular distance from each other at an angle α of 60°. The support elements 30 center the hollow gear 16 in the gear housing 4.

The support elements 30 retain the hollow gear 16 in a relatively precisely centered position in the gear housing 4. Simultaneously, the intermediate planetary stage 12 is also centered relative to the gear housing 4. With a such substantially central support of the gear block, it is centered over its entire axial length even when the power tool is turned off. This prevents vibrations and wear of the planetary gear components when the power tool is turned on.

Though the present invention was shown and described with references to the preferred embodiment, such is merely illustrative of the present invention and is not to be construed as a limitation thereof and various modifications of the present invention will be apparent to those skilled in the art. It is, therefore, not intended that the present invention be limited to disclosed embodiment or details thereof, and the present invention includes all variations and/or alternative embodiments within the spirit and scope of the present invention as defined by the appended claims.

1. A planetary gear (7), comprising a gear housing (4); a gear block (6) having at least two planetary stages (12, 14) and at least partially located in the housing (4); and a hollow gear (16) arranged between the housing (4) and the gear block (6) and axially displaceable relative to the housing (4) for shifting the planetary gear (7) between at least two shifting stages, the gear housing (4) having, on an inner surface (28) thereof, at least two support elements (3) against which the hollow g (16) is supported.

2. A planetary gear according to claim 1, wherein the support elements (3) support an intermediate planetary stage (12) that is arranged between two other stages (14).

3. A planetary gear according to claim 1, wherein the support elements (30) are formed by ribs projecting from the inner surface (28) of the gear housing (4).

4. A planetary gear according to claim 1, wherein the gear housing (4) has, on the inner surface (28) thereof, at least three support elements (30) which are formed as ribs projecting from the inner surface (28).

5. A planetary gear according to claim 4, wherein the at least three ribs are equidistantly angularly spaced from each other.
